(19) United States
(12) Patent Application Publication
(10) Pub. No.: US 2019/0370421 A1
(43) Pub. Date: Dec. 5, 2019

(54) SYSTEMS AND METHODS FOR GRAPHICALLY SIMULATING AND VISUALIZING A NETWORKED FIRE ALARM SYSTEM

(71) Applicant: Honeywell International Inc., Morris Plains, NJ (US)

(72) Inventors: Rajesh Babu Nalukurthy, Bangalore (IN); Aatish Sethi, Bangalore (IN); Balamurugan Venkatesh, Hosur (IN)

(21) Appl. No.: 16/429,353

(22) Filed: Jun. 3, 2019

(30) Foreign Application Priority Data
Jun. 1, 2018 (IN) 201811020637

(51) Int. Cl. G06F 17/50; G08B 29/14

(52) U.S. Cl. CPC G06F 17/5009; G06F 17/5004; G08B 29/145

(57) ABSTRACT

Methods, devices, and systems for graphically simulating and visualizing a networked fire alarm system are described herein. In some examples, one or more embodiments include a computing device comprising a memory and a processor to execute instructions stored in the memory to receive a site-specific job file for a site and an associated graphical floor plan for the site, generate a visualization of the networked fire alarm system for the site, and display the visualization of the networked fire alarm system via a graphical user interface.

### PRIORITY INFORMATION

This application is claims priority to India Provisional Patent 201811020637, filed Jun. 1, 2018, the contents of which is hereby incorporated by reference.

### TECHNICAL FIELD

The present disclosure relates generally to fire alarm systems. More particularly, the present invention relates to systems and methods for graphically simulating and visualizing a networked fire alarm system

### BACKGROUND

During installation of a networked fire alarm system at a site, a technician must undergo a series of tedious activities, such as creating a job file, configuring required rules, downloading data to a fire alarm control panel, and testing the rules as configured for the job file. Indeed, when the job file is complex, there can be many rules to be configured. Accordingly, the installation can consume a large amount of resources in terms of time, effort, and cost, and it can be a tedious job to ensure that all devices in the networked fire alarm system are working as expected at the site.

In view of the above, there is a continuing, ongoing need for improved systems and methods.

### BRIEF DESCRIPTION OF THE DRAWINGS

FIG. 1 is an example of an illustration of a visualization of a networked fire alarm system in accordance with disclosed embodiments.

FIG. 2 is an example of an illustration of a visualization of a networked fire alarm system having devices in accordance with disclosed embodiments.

FIG. 3 is an example of an illustration of a portion of a visualization of a networked fire alarm system in accordance with disclosed embodiments.

FIG. 4 is an example of an illustration of a visualization of a networked fire alarm system having rules in accordance with disclosed embodiments.

FIG. 5 is an example of an illustration of a visualization of a networked fire alarm system scaling a rule in accordance with disclosed embodiments.

FIG. 6 is an example of an illustration of a visualization of a networked fire alarm system scaling a rule in accordance with disclosed embodiments.

FIG. 7 is an example of a computing device for graphically simulating and visualizing a networked fire alarm system, in accordance with disclosed embodiments.

### DETAILED DESCRIPTION

Methods, devices, and systems for graphically simulating and visualizing a networked fire alarm system are described herein. In some examples, one or more embodiments include a computing device comprising a memory and a processor to execute instructions stored in the memory to receive a site-specific job file for a site and an associated graphical floor plan for the site, generate a visualization of the networked fire alarm system for the site, and display the visualization of the networked fire alarm system via a graphical user interface.

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods for graphically simulating conditions of a networked fire alarm system and visualizing expected outcomes on a graphical floor plan. Such systems and methods can save resources during on-site installation of the networked fire alarm system because such systems and methods can be executed in a factory and prior to the on-site installation.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

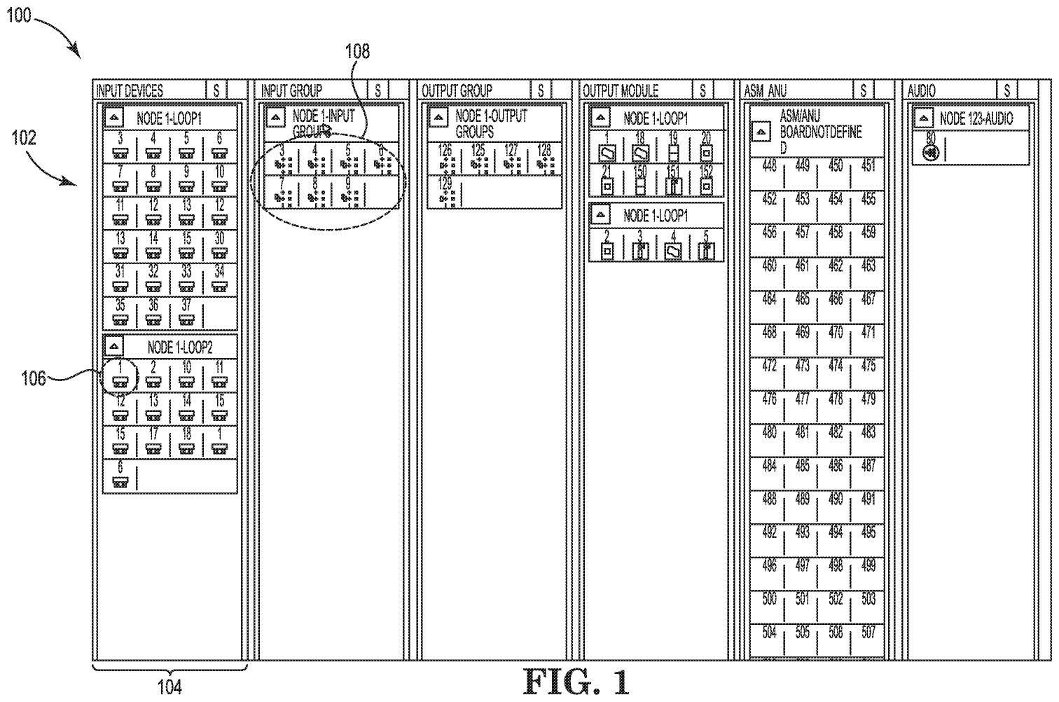

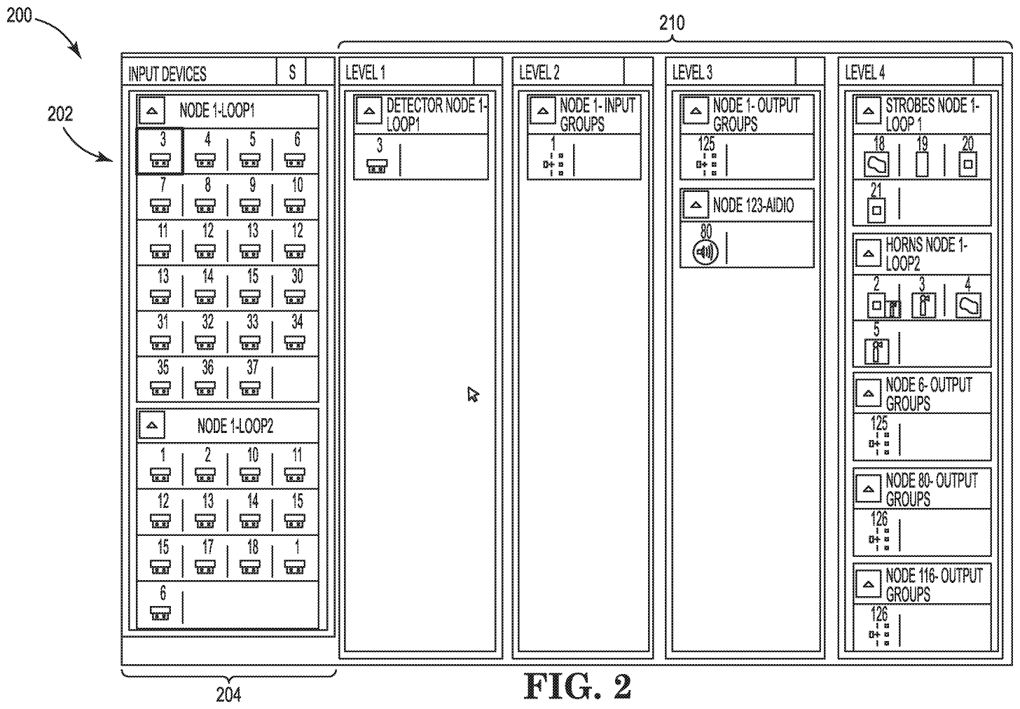

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 is an example of an illustration of a visualization 100 showing a networked fire alarm system 102 in accordance with disclosed embodiments. As illustrated in FIG. 1, the visualization 100 of the networked fire alarm system 102 can include devices 104, a tagged device 106, and a plurality of tagged devices 108.

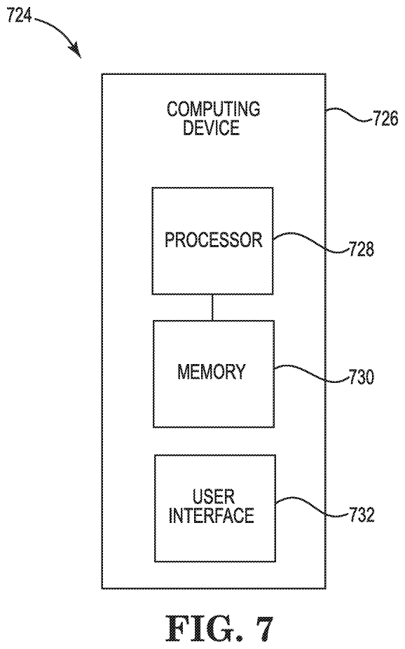

The visualization 100 can be displayed on a computing device, as will be further described herein (e.g., in connection with FIG. 7). As used herein, the term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone (e.g., a smart phone), a tablet, a personal digital assistant (PDA), smart glasses, and/or a wrist-worn device (e.g., a smart watch), among other types of mobile devices.

The computing device can be used to graphically simulate and/or visualize a networked fire alarm system. For example, the computing device can be utilized to generate a visualization of a networked fire alarm system for a site and display the visualization on a user interface. Generating the visualization of the networked fire alarm system can allow a user to ensure all devices in the networked fire alarm system are working as expected, as is further described herein.

The computing device can receive a site-specific job file for a site and an associated graphical floor plan for the site. As used herein, the term “site” can refer to a facility. A facility can be, for example, a commercial facility, office building, etc. Such facilities may include various devices associated with the networked fire alarm system. As used herein, the term “device” can, for example, refer to a fire safety device. Fire safety devices can include smoke detectors, heat detectors, carbon monoxide (CO) detectors, alarms, (e.g., audible, visual, etc.), displays, fire control panels, among other examples of fire safety devices.

The site-specific job file can include an associated graphical floor plan for the site. The site-specific job file can include information about a site, including devices included at the site, control systems for included devices, the graphical floor plan for the site, among other information. In some examples, the site-specific job file can be, for instance, a building information model. As used herein, a building information model can include building information modeling data associated with a building managed by a building automation system. The building information modeling data can include characteristics, such as data associated with (e.g., quantities, properties, and/or statuses of) the components (e.g., control components), equipment, devices, networks (e.g., control networks), areas, and/or properties of the building. For example, the building information modeling data can include architectural, mechanical, electrical, plumbing, sanitary, fire, geometrical, and/or spatial (e.g., spatial relationship) information associated with the building.

For example, a building information model can include characteristics such as a floor plan (e.g., an architectural layout, such as an area, floor and/or room layout) of the building, available sensors, relationships between devices (e.g., energy flows, control network, fire safety devices, etc.) and heating, ventilation, and air conditioning (HVAC) devices (e.g., HVAC equipment) in (e.g., located and/or used in) the building, among other types of building information modeling data. The HVAC devices in the building can include, for example, a chiller(s) (e.g., chiller plant), boiler(s) (e.g., boiler plant), pump(s), fan(s), air damper(s) such as a variable air volume (VAV) damper, air handling unit(s) (AHUs) (e.g., AHU plant), coil(s) such as a heating and/or cooling coil, air filter(s), heat pump(s), and/or cooling tower(s), among other HVAC devices. The fire safety devices can include smoke detectors, heat detectors, carbon monoxide (CO) detectors, alarms, (e.g., audible, visual, etc.), displays, fire control panels, among other examples of fire safety devices. The computing device can process the data included in the site-specific job file and render devices in the networked fire alarm system and associations therewith.

The computing device can tag a device 106 in the networked fire alarm system with an area in the site. For example, the computing device can create an association between a particular device 106 (e.g., a fire alarm) with an area in the site, such as a conference room. As illustrated in FIG. 1, the device 106 can be included in “NODE1-LOOP 2” of the input devices 104.

Although the computing device is described above as tagging a single device 106 with an area in the site, embodiments of the disclosure are not so limited. For example, the computing device can tag (e.g., create an association between) a plurality of devices in the networked fire alarm system with an area in the site. For instance, the computing device can tag a plurality of devices 108 (e.g., a group of fire alarm sensors) with an area in the site such as an open office area. As illustrated in FIG. 1, the plurality of devices 108 can be included in “NODE 1-INPUT GROUPS” of an “INPUT GROUP”.

The computing device can generate a visualization 100 of the networked fire alarm system for the site. As used herein, the term “visualization” refers to a perceptible image of an object. For example, the visualization 100 of the networked fire alarm system can be an image of the networked fire alarm system that is perceptible (e.g., viewable) by the user via a user interface of the computing device. For instance, the visualization 100 of the networked fire alarm system can illustrate to a user devices 106/plurality of devices 108, their tagged areas within a site, associations therebetween (e.g., device connections, associations with other devices, etc.), zones included in the site, devices associated with the zones, among other illustratable information about the networked fire alarm system for the site.

Generating the visualization of the networked fire alarm system can include identifying zones in the site in which the networked fire alarm system is to be installed. For example, the site may include a conference room, an open office area, and/or a courtyard, among other areas of a site. The computing device can identify which of the zones in the site in which the networked fire alarm system is to be installed. For example, the computing device can identify the conference room and the open office area as zones in the site in which the networked fire alarm system is to be installed.

The computing device can identify zones in the site in which the networked fire alarm system is to be installed that are used. Continuing with the example from above, the computing device can identify the conference room and the open office area as zones in the site in which the networked fire alarm system is to be installed, and that the open office area is to be used.

Additionally, the computing device can identify zones in the site in which the networked fire alarm system is to be installed that are not used. Continuing with the example from above, the computing device can identify the conference room and the open office area as zones in the site in which the networked fire alarm system is to be installed, and that the conference room is not to be used.

The computing device can generate the visualization of the networked fire alarm system by identifying devices in the site in which the networked fire alarm system is to be installed. For example, the computing device can identify devices (e.g., included in the site-specific job file) to be installed. For instance, the computing device can identify various fire safety devices (e.g., smoke detectors, fire control panels, audible alarms, etc.) which are to be installed in various zones (e.g., a conference room, an open office area, etc.) in the site.

The computing device can identify devices in the site in which the networked fire alarm system is to be installed that are used. Continuing with the example from above, the computing device can identify the open office area as a zone in the site, and that smoke detectors and heat detectors are to be installed in the open office area. The computing device can further identify the smoke detectors as the devices to be installed that are going to be used.

The computing device can identify devices in the site in which the networked fire alarm system is to be installed that are not used. Continuing with the example from above, the computing device can identify the open office area as a zone in the site, and that smoke detectors and heat detectors are to be installed in the open office area. The computing device can further identify the heat detectors as the devices to be installed that are not going to be used. Accordingly, while the open office area may include smoke detectors and heat detectors, the smoke detectors can be in use but not the heat detectors.

The computing device can display the visualization 100 of the networked fire alarm system via a graphical user interface. The graphical user interface can be user interface 732, as is further described in connection with FIG. 7.

Displaying the visualization 100 of the networked fire alarm system can include displaying the graphical floor plan. For example, the display of the graphical floor plan can include zones in the site in which the networked fire alarm system is to be installed and devices in the site in which the networked fire alarm system is to be installed. For instance, the displayed graphical floor plan can include a conference room and an open office area and can include smoke detectors in the open office area, among other examples.

Generating the visualization 100 of the networked fire alarm system can include labeling devices with names that are the same as objects included in the graphical floor plan for the site. For example, objects in the graphical floor plan can be included in “NODE 1-INPUT GROUPS” and can be labeled numerically as 3, 4, 5, 6, 7, 8, and 9. Accordingly, the computing device can label the devices numerically (e.g., as illustrated in FIG. 1) as 3, 4, 5, 6, 7, 8, and 9 and can be included in the “NODE 1-INPUT GROUPS” list. Similarly, an object in the graphical floor plan labeled as “SMOKE DETECTOR 1-101” can be labeled as “SMOKE DETECTOR 1-101” by the computing device when generating the visualization 100, among other examples.

FIG. 2 is an example of an illustration of a visualization 200 of a networked fire alarm system 202 having devices 204 in accordance with disclosed embodiments. As illustrated in FIG. 2, the visualization 200 of the networked fire alarm system 202 can include devices 204 and bi-directional connections 210. The visualization 200 can be displayed on a computing device, as will be further described herein (e.g., in connection with FIG. 7).

The computing device can simulate activation of an output device included in the devices 204 in the networked fire alarm system. Simulation of activation of an output device can include activation of the output device. In some examples, the device can be a fire alarm, and simulating activation of the fire alarm can include activating the physical fire alarm to cause audible noise output from the fire alarm. In some examples, the device can be a fire alarm, and simulating activation of the fire alarm can include causing the fire alarm to generate an output (e.g., a signal to send to, for instance, a fire control panel indicating activation of the fire alarm) without causing audible noise output from the fire alarm.

Although the output device is described above as being a fire alarm, embodiments of the disclosure are not so limited. For example, the output device can be any other fire safety device as described herein.

Simulating activation of the output device can include identifying all possible reasons for activation of the output device. Continuing with the example from above, the computing device can identify reasons for activation of the output device (e.g., the fire alarm), such as detection of a fire, pulling of a manual fire alarm, etc. The identified possible reasons for activation can be displayed via the graphical user interface. For example, the graphical user interface can receive a user input selecting one of the output devices, and the computing device can identify all the reasons for the activation of the output device as well as bidirectional connections (e.g., as is further described herein) with the output device, including other devices providing input to the one of the output devices and other devices to which the one of the output devices provides input. For example, the computing device can display detection of the fire, pulling of the manual fire alarm, among other identified reasons for activation of the fire alarm.

The computing device can identify bidirectional connections 210 with the output device. For example, the output device can be a fire alarm. The fire alarm can include bidirectional connections 210 with other devices included in the networked fire alarm system 200. As illustrated in FIG. 2, activation of the fire alarm may include causing a fire detector included in “LEVEL 1” to activate, and through (e.g., LEVEL 2 and LEVEL 3) “NODE 1-INPUT GROUPS” and “NODE 1-OUTPUT GROUPS” cause activation of “NODE 123-AUDIO”. In other words, bidirectional connections 210 can be other devices associated with the output device being activated in the simulation. In addition to the audio output (e.g., identified by the bidirectional connection with “NODE 123-AUDIO”, other outputs (e.g., through LEVEL 4) can be activated, such as strobes (e.g., via STROBES NODE 1-LOOP 1, HORNS NODE 1-LOOP2, etc.).

In other words, the computing device can simulate activation of a device (e.g., a condition on an input device) in the networked fire alarm system and, as illustrated in FIG. 2, graphically visualize through multiple levels, associated outputs that are mapped in accordance with rules in the site-specific job file. For example, a first output device in the networked fire alarm system can trigger a second output device in the networked fire alarm system which, after some delay, can trigger a third output device in the networked fire alarm system. In some examples, any of the output devices in the networked fire alarm system can play audio messages.

The computing device can display the visualization of the networked fire alarm system and the simulation results of the simulated activation of the output device via the graphical user interface. For example, the computing device can display the bidirectional connections 210, reasons for activation, etc. Visualization of the networked fire system in this way can provide clarity for users who may be trouble shooting the system.

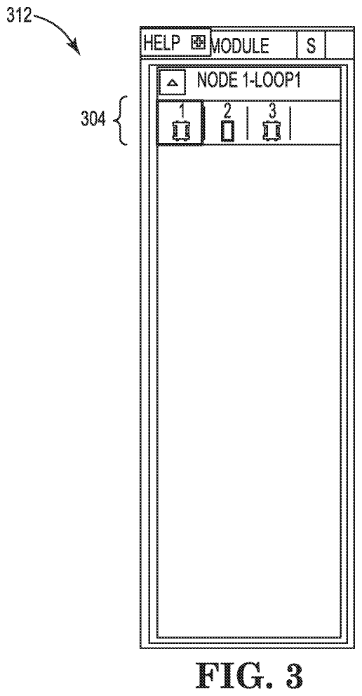

FIG. 3 is an example of an illustration of a portion 312 of a visualization of a networked fire alarm system in accordance with disclosed embodiments. As illustrated in FIG. 3, the portion 312 of the visualization of the networked fire alarm system can include devices 304. The portion 312 of the visualization can be displayed on a computing device, as will be further described herein (e.g., in connection with FIG. 7).

As previously described in connection with FIG. 1, the computing device can tag a device and/or a plurality of devices in the networked fire alarm system with an area in the site. For example, as illustrated in FIG. 3, the computing device can tag devices 304. Devices 304 can include two fire alarms and a heat detector, among other examples of devices. The devices 304 can be displayed as being included in “NODE 1-LOOP1” in the site.

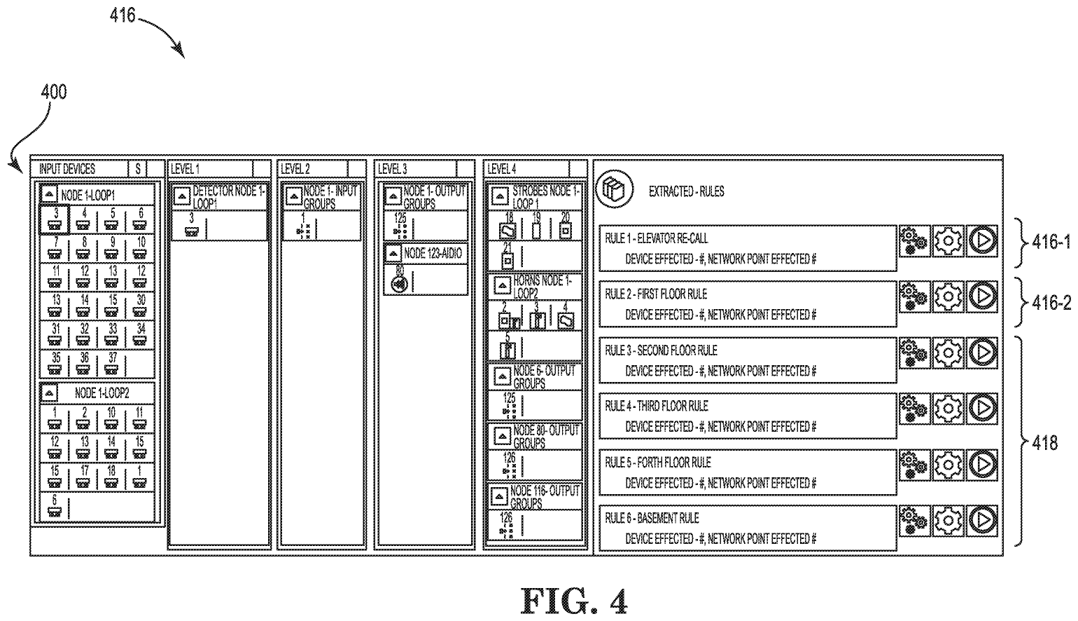

FIG. 4 is an example of an illustration of a visualization 400 of a networked fire alarm system having rules 416 and 418 in accordance with disclosed embodiments. The visualization 400 can include rules 416, including rules 416-1 and 416-2 and rule 418. The visualization 400 can be displayed on a computing device, as will be further described herein (e.g., in connection with FIG. 7).

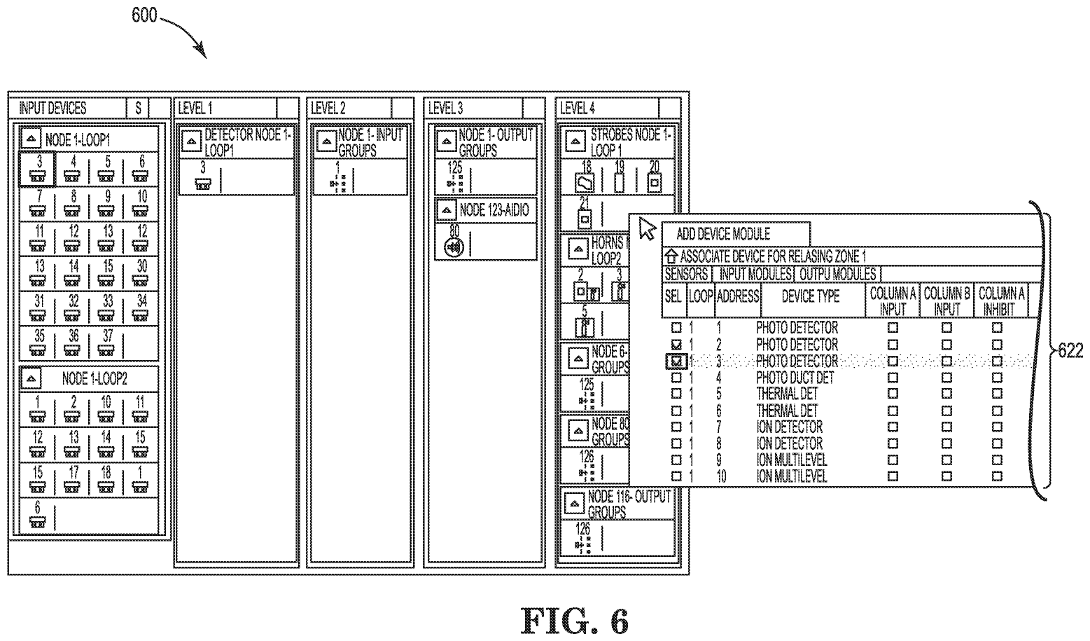

The computing device can create a rule based on a tagged device and the area in the site. For example, the computing device can create a rule involving a fire detector, a first floor of the site, and a conference room of the site. For example, the computing device can create a rule such that activation of the fire detector can cause other actions in relation to the first floor and/or the conference room of the site. For instance, activation of the fire detector can cause other devices, such as alarms, to activate on the first floor of the site and/or in the conference room of the site. In some examples, the computing device can create a rule in response to a user input (e.g., received via the graphical user interface of the computing device to tag the fire detector to both the first floor and the conference room in the site). In some examples, the computing device can scale the rule by adding a plurality of devices included in the networked fire alarm system to the rule, as is further described in connection with FIG. 6.

In some examples, the computing device can create rule 416-1. For example, rule 416-1 can specify an elevator to be re-called in response to a particular device being activated. For instance, activation of a fire alarm can cause RULE 1—ELEVATOR RE-CALL (e.g., as illustrated in FIG. 4).

In some examples, the computing device can create rule 416-2. For example, rule 416-2 can specify a rule on a first floor of the site. For instance, activation of an alarm can cause RULE 2—FIRST FLOOR RULE to activate, which may include activation of an alarm in response to detection of a fire by a fire detector.

The computing device can create a rule based on a plurality of tagged devices and an area in the site. For example, the computing device can create a rule involving three fire detectors and a first floor of the site. For example, the computing device can create a rule such that activation of any one of the three fire detectors can cause other actions in relation to the first floor (e.g., activation of an audible alarm, etc.).

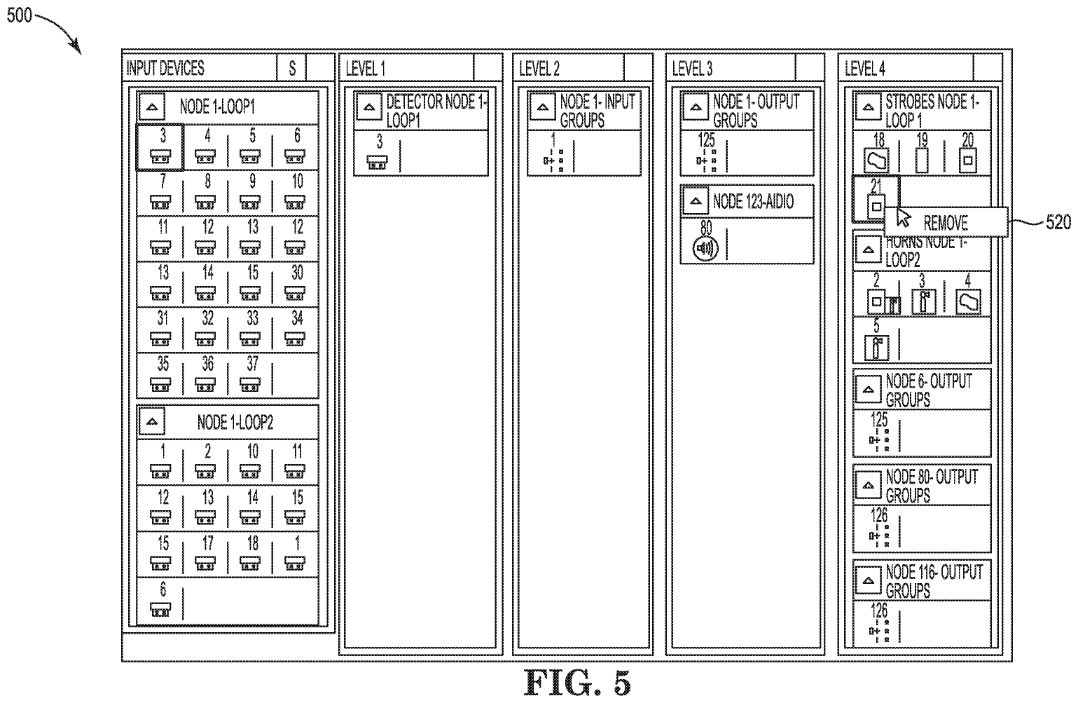

The computing device can create a rule based on a tagged device (e.g., or a plurality of tagged devices) and a plurality of areas in the site. For example, the computing device can create a rule involving a fire detector and a second, third, fourth floor, and basement. For example, the computing device can create rule 418 such that activation of a fire detector (e.g., or multiple fire detectors) can cause other actions in relation to the second floor, third floor, fourth floor, and/or basement (e.g., activation of audible alarms, etc.). In some examples, the computing device can scale the rule by removing a device included in the networked fire alarm system from the rule, as is further described in connection with FIG. 5.

Creation of a rule can allow a user to identify one or more entities needed in a cause and identify one or more entities needed in an effect, and responsive thereto, the computing device can intelligently and efficiently manage virtual groups of rules, modify or add logical equations/expressions to the rules, etc.

As previously described above, the computing device can dynamically correct, scale, or apply the rules configured in the site-specific job file during simulation by automatically managing the logical equations/expressions defining the rules and the virtual groups defined by the rules.

In some examples, the computing device can conduct a behavioral study of data from the site-specific job file. For example, using data analytics, the computing device can infer a rule from the data included in the site-specific job file.

FIG. 5 is an example of an illustration of a visualization 500 of a networked fire alarm system scaling a rule in accordance with disclosed embodiments. The visualization 500 can include removing a device 520. The visualization 500 can be displayed on a computing device, as will be further described herein (e.g., in connection with FIG. 7).

As previously described in connection with FIG. 4, the computing device can create rules based on a tagged device (e.g., or a plurality of tagged devices) and an area (e.g., or a plurality of areas) in a site. In some examples, the computing device can scale a rule. For example, scaling a rule can include removing a device from the rule.

For instance, the computing device can create a rule including three fire detectors for a first floor of a site. Activation of any one of the three fire detectors can cause activation of an alarm in the first floor. The computing device can scale the rule by removing a device 520 from one of the three fire detectors. For example, removal of a fire detector can scale the rule such that activation of any one of the two remaining fire detectors can cause activation of an alarm in the first floor. In other words, activation of the removed third fire detector may not cause activation of the alarm on the first floor, since the third fire detector is removed from the rule. In other words, the computing device can delete or remove one or more of the devices in the networked fire alarm system from one of the rules. In some examples, the computing device can delete or remove the one or more devices from the one of the rules in response to a user input (e.g., received via the graphical user interface of the computing device).

FIG. 6 is an example of an illustration of a visualization 600 of a networked fire alarm system scaling a rule in accordance with disclosed embodiments. The visualization 600 can include adding a device 622. The visualization 600 can be displayed on a computing device, as will be further described herein (e.g., in connection with FIG. 7).

As previously described in connection with FIG. 4, the computing device can create rules based on a tagged device (e.g., or a plurality of tagged devices) and an area (e.g., or a plurality of areas) in a site. In some examples, the computing device can scale a rule. For example, scaling a rule can include adding a device to the rule.

For instance, the computing device can create a rule including three fire detectors for a first floor of a site. Activation of any one of the three fire detectors can cause activation of an alarm in the first floor. The computing device can scale the rule by adding a device 622 to the three fire detectors. For example, as illustrated in FIG. 6, the computing device can scale the rule by adding a photo detector to the rule such that activation of any one of the three fire detectors or the photo detector can cause activation of an alarm in the first floor. In other words, the computing device can apply one of the rules to one or more devices in the networked fire alarm system by adding the one or more devices to the one of the rules. In some examples, the computing device can add the one or more devices to the one of the rules in response to a user input (e.g., received via the graphical user interface of the computing device).

Graphically simulating and visualizing a networked fire alarm system, in accordance with the present disclosure, can allow for a user to easily view a graphical visualization through multiple levels of a networked fire alarm system in accordance with a site-specific job file. Such a visualization method can save resources during on-site installation of the networked fire alarm system because such systems and methods can be executed in a factory and prior to the on-site installation, as compared with previous approaches.

FIG. 7 is an example of a computing device 726 for graphically simulating and visualizing a networked fire alarm system, in accordance with disclosed embodiments. The computing device 726 can include a processor 728, memory 730, and a user interface 732.

The memory 730 can be any type of storage medium that can be accessed by the processor 728 to perform various examples of the present disclosure. For example, the memory 730 can be a non-transitory computer readable medium having computer readable instructions (e.g., computer program instructions) stored thereon that are executable by the processor 728 for fire control panel interface generation in accordance with the present disclosure.

The memory 730 can be volatile or nonvolatile memory. The memory 730 can also be removable (e.g., portable) memory, or non-removable (e.g., internal) memory. For example, the memory 730 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 730 is illustrated as being located within the computing device 726, embodiments of the present disclosure are not so limited. For example, memory 730 can also be located internal to another computing resource (e.g., enabling computer readable instructions to be downloaded over the Internet or another wired or wireless connection).

As illustrated in FIG. 7, the computing device 726 can include a user interface 732. For example, the user interface 732 can display a visualized networked fire alarm system generated in accordance with the present disclosure (e.g., as previously described in connection with FIGS. 1-6).

A user (e.g., operator) of the computing device 726 can interact with the computing device 726 via user interface 732. For example, user interface 732 can provide (e.g., display and/or present) information to the user of the computing device 726, and/or receive information from (e.g., input by) the user of the computing device 726. For instance, in some embodiments, user interface 732 can be a graphical user interface (GUI) that can provide and/or receive information to and/or from the user of the computing device 726. The user interface 732 can be, for instance, a touchscreen (e.g., the GUI can include touchscreen capabilities). Alternatively, the user interface 732 can be a television, computer monitor, mobile device screen, other type of display device, or any combination thereof, connected to the computing device 726 and configured to receive a video signal output from the computing device 726.

As an additional example, the user interface 726 can include a keyboard and/or mouse the user can use to input information into computing device 726. Embodiments of the present disclosure, however, are not limited to a particular type(s) of user interface.

User interface 732 can be localized to any language. For example, user interface 732 can display the aircraft stand management in any language, such as English, Spanish, German, French, Mandarin, Arabic, Japanese, Hindi, etc.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for graphically simulating a networked fire alarm system, comprising:
a memory; and
a processor configured to execute instructions stored in the memory to:
receive a site-specific job file for a site and an associated graphical floor plan for the site;
generate a visualization of the networked fire alarm system for the site; and
display the visualization of the networked fire alarm system via a graphical user interface.

2. The computing device of claim 1, wherein the processor is configured to execute the instructions to simulate activation of an output device included in the networked fire alarm system.

3. The computing device of claim 2, wherein simulating activation of the output device includes instructions to:
identify all possible reasons for activation of the output device; and
display the possible reasons for the activation of the output device via the graphical user interface.

4. The computing device of claim 2, wherein simulating activation of the output device includes instructions to:
identify bidirectional connections with the output device; and
display the bidirectional connections with the output device via the graphical user interface.

5. The computing device of claim 1, wherein the processor is configured to execute the instructions to tag a device in the networked fire alarm system with an area in the site.

6. The computing device of claim 5, wherein the processor is configured to execute the instructions to create a rule based on the tagged device and the area in the site.

7. The computing device of claim 6, wherein the processor is configured to execute the instructions to scale the rule by adding a plurality of devices included in the networked fire alarm system to the rule.

8. The computing device of claim 1, wherein the processor is configured to execute the instructions to tag a plurality of devices in the networked fire alarm system with an area in the site.

9. The computing device of claim 8, wherein the processor is configured to execute the instructions to create a rule based on the plurality of tagged devices and the area in the site.

10. The computing device of claim 9, wherein the processor is configured to execute the instructions to scale the rule such by removing a device from the plurality of devices in the networked fire alarm system from the rule.

11. A system for graphically simulating a networked fire alarm system, comprising a computing device configured to:
receive a site-specific job file for a site and an associated graphical floor plan for the site;
generate a visualization of the networked fire alarm system for the site;
simulate activation of an output device included in the networked fire alarm system; and
display the visualization of the networked fire alarm system and simulation results of the simulated activation of the output device via a graphical user interface.

12. The system of claim 11, wherein the computing device is configured to generate the visualization of the networked fire alarm system including identifying zones in the site in which the networked fire alarm system is to be installed.

13. The system of claim 12, wherein the computing device is configured to identify zones in the site in which the networked fire alarm system is to be installed that are used.

14. The system of claim 12, wherein the computing device is configured to identify zones in the site in which the networked fire alarm system is to be installed that are not used.

15. The system of claim 11, wherein the computing device is configured to generate the visualization of the networked fire alarm system including identifying devices in the site in which the networked fire alarm system is to be installed.

16. The system of claim 15, wherein the computing device is configured to identify devices in the site in which the networked fire alarm system is to be installed that are used.

17. The system of claim 15, wherein the computing device is configured to identify devices in the site in which the networked fire alarm system is to be installed that are not used.

18. A computer implemented method for graphically simulating a networked fire alarm system, comprising:
receiving, by a computing device, a site-specific job file for a site and an associated graphical floor plan for the site;
generating, by the computing device, a visualization of the networked fire alarm system for the site;
simulating, by the computing device, activation of an output device included in the networked fire alarm system; and
displaying, by the computing device, the visualization of the networked fire alarm system and simulation results of the simulated activation of the output device via a graphical user interface.

19. The method of claim 18, wherein displaying the visualization of the networked fire alarm system includes displaying the graphical floor plan including:
zones in the site in which the networked fire alarm system is to be installed; and
devices in the site in which the networked fire alarm system is to be installed.

20. The method of claim 18, wherein generating the visualization of the networked fire alarm system includes labeling devices with names that are the same as objects included in the graphical floor plan for the site.
